(19) United States
(12) Patent Application Publication
(10) Pub. No.: US 2004/0193555 A1
(43) Pub. Date: Sep. 30, 2004

(54) Method and system for selecting a procedure for shipping

(76) Inventor: Michael Chew, San Jose, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/395,603

(22) Filed: Mar. 24, 2003

(51) Int. Cl. G06F 17/60

(52) U.S. Cl. 705/410

(57) ABSTRACT

Embodiments of the invention include a method for selecting a procedure for shipping a product, comprising: creating a set of delivery procedures with each delivery procedure having a destination code, a delivery time, and a cost of delivery; receiving a purchase order having a requested delivery time for a purchased product and a product-destination code for the purchased product; and selecting from the set a delivery procedure having the lowest cost of delivery and the same delivery time and the same destination code as the requested delivery time and product-destination code. Embodiments of the invention include a system for selecting a procedure for shipping a product, comprising: a storage device configured to store a set of delivery procedures with each delivery procedure having a destination code, a delivery time, and a cost of delivery; a receiving device configured to receive a purchase order having a requested delivery time for a purchased product and a product-destination code for the purchased product; and a processor coupled to the storage device and to the receiving device and configure to select from the set a delivery procedure having the lowest cost of delivery and the same delivery time and the same destination code as the requested delivery time and product-destination code.

### TECHNICAL FIELD

Embodiments of the invention relate generally to placing an order for a product in an electronic commerce environment, such as by telephone or through a computer network. More particularly, embodiments of the invention relate to a method and system for selecting a cost-effective procedure for shipping a commercial product to a desired destination.

### BACKGROUND ART

Conventional methods and systems for shipping a commercial product to a desired destination after a customer places an order allows customers to choose specific delivery methods for their orders. Such methods and systems give merchants less flexibility when trying to minimize shipping expenses and maximize profit, especially since the merchants must use methods specified by the customer notwithstanding the availability of more cost-effective methods and systems. If merchants could choose the most cost-effective procedure for shipping a commercial product to a customer, merchants would be in a position increase profits through minimizing the cost of shipping.

### SUMMARY OF EMBODIMENTS OF THE INVENTION

In an embodiment of the invention, a method for selecting a procedure for shipping a product, includes: creating a set of delivery procedures with each delivery procedure having a destination code, a delivery time, and a cost of delivery; receiving a purchase order having a requested delivery time for a purchased product and a product-destination code for the purchased product; and selecting from the set a delivery procedure having the lowest cost of delivery and the same delivery time and the same destination code as the requested delivery time and product-destination code.

In another embodiment of the invention, a system for selecting a procedure for shipping a product, includes: a storage device configured to store a set of delivery procedures with each delivery procedure having a destination code, a delivery time, and a cost of delivery; a receiving device configured to receive a purchase order having a requested delivery time for a purchased product and a product-destination code for the purchased product; and a processor coupled to the storage device and to the receiving device and configure to select from the set a delivery procedure having the lowest cost of delivery and the same delivery time and the same destination code as the requested delivery time and product-destination code.

These provisions together with the various ancillary provisions and features which will become apparent to those artisans possessing skill in the art as the following description proceeds are attained by devices, assemblies, systems and methods of embodiments of the invention, various embodiments thereof being shown with reference to the accompanying drawings, by way of example only, wherein:

### BRIEF DESCRIPTION OF THE DRAWINGS

FIG. 1 is a schematic block diagram that exemplarily illustrates a computer system which may be employed for various embodiments of the invention.

FIG. 2 is a functional diagram illustrating a computer network where embodiments of the invention may be employed.

FIG. 3 illustrates a schematic diagram of a system for creating and publishing web pages which may be employed for various embodiments of the invention.

FIG. 4 is a block flow diagram in accordance with an embodiment of the invention for selecting a delivery procedure for a product.

### DETAILED DESCRIPTION OF EMBODIMENTS OF THE INVENTION

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the invention.

A “computer” for purposes of embodiments of the invention may be any processor-containing device, such as a mainframe computer, a personal computer, a laptop, a notebook, a microcomputer, a server, or any of the like. A “computer program” may be any suitable program or sequence of coded instructions which are to be inserted into a computer, and well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

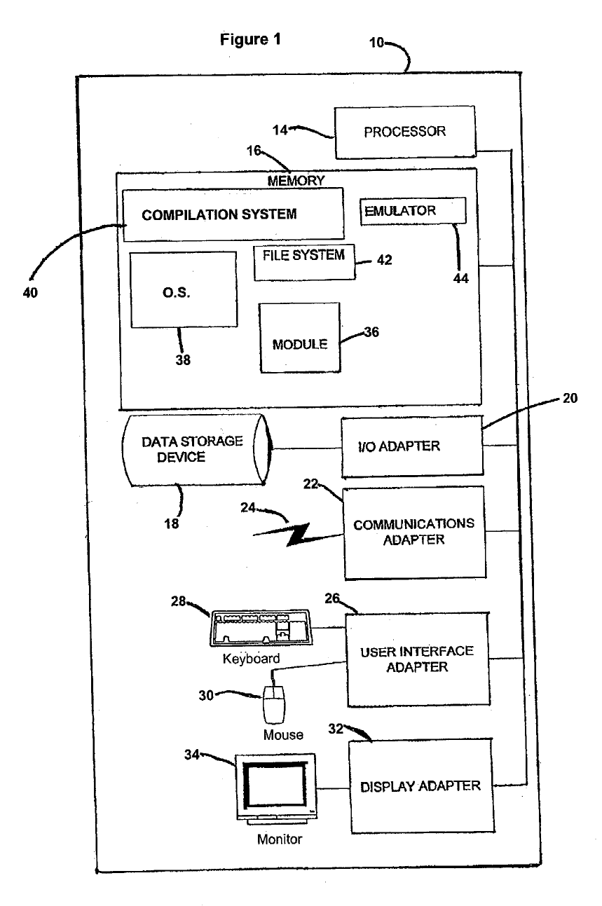

Referring now to FIG. 1 there is broadly illustrated a computer system 10 which may be employed for various embodiments of the invention. The computer system 10 includes a computer program and various components, such as a processor 14, a computer memory 16, a data storage device 18, an input/output (I/O) adapter 20, a communications adapter 22, a communications network 24, a user interface adapter 26, a keyboard 28, a mouse 30, a display adapter 32, and a computer monitor 34. It is to be understood and appreciated by those skilled in the relevant art that there are many possible configurations and arrangements of the components of the computer system 10 and that some components which may be typically included in the computer system 10 are not shown. Thus, the computer system 10 illustrated in FIG. 1 is for exemplarily purposes only and is not to unduly limit the spirit and scope of embodiments of the invention.

Computer memory 16 may be any suitable memory storage device, including random access memory (RAM), cache memory, magnetic medium such as a resident hard disk, or other memory storage devices. The term “storage” may refer to computer resources, such as the computer memory 16, and may be employed to store suitable data or instructions. For exemplarily purposes only and as best illustrated in FIG. 1, computer memory 16 may include at least one module 36, an operating system (O.S.) 38, a compilation system 40, a file system 42, and an emulator 44.

The compilation system 40 for various embodiments of the invention would comprise a compiler having a special program that processes statements written in a particular programming language and turns them into machine language or “code” that a processor, such as processor 14, uses. Traditionally, the output of a compilation system, such as compilation system 40, has been called object code or sometimes an object module. It is well known that the object code is machine code that the processor of the computer can process or “execute” one instruction at a time. Thus, stated alternatively, the compiler translates source code into object code, particularly by looking at the entire piece of source code and collecting and reorganizing the instructions.

Continuing to refer to FIG. 1 the processor 14 typically operates in cooperation with suitable software programs, including the computer memory 16, more particularly including the compilation system 40, the O.S. 38 and the module 36. Henceforth, the fact of such cooperation among the processor 14 and these components of the computer memory 16, whether implemented in software, hardware, firmware, or any combination thereof, may therefore not be repeated or further described, but will be implied for purposes of various embodiments of the invention. It is well known that a module, such as the module 36, typically operates in cooperation with the emulator 44 and the compilation system 40, but is not limited to such operation. By way of example only, the module 36 may operate in cooperation with the O.S. 38, which may in itself cooperate with the compilation system 40. The O.S. 38 may also cooperate with the file system 42 that manages the storage and access to files within the computer system 10.

The module 36 may be implemented in any suitable program language, or in any combination of software, hardware, or firmware. Thus, the module 36 may include instructions and data and be embodied in a computer-readable medium for use by or in connection with an instruction execution system, apparatus, or device, such as the computer system 10 which may pursue and derive any suitable instructions for operation. Any function ascribed to the module 36 and any of its associated functional files, whether implemented in software, hardware, firmware, or any combination thereof, may be included in the functions of the O.S. 38, since the O.S. 38 may include files from the module 36. In some instances, the functions ascribed to the module 36 may be typically performed by the processor 14 executing suitable software instructions in cooperation with aspects of the O.S. 38 that may incorporate the module 36. Therefore, it is to be understood that the module 36 may cooperate with aspects of the O.S. 38.

It will be appreciated by those skilled in the relevant art that the term “execute” may mean the process of manipulating code, such as software, for operation on the computer system 10. It will be further appreciated by those skilled in the relevant art that the term “code” may refer to any suitable instructions or data used by the computer system 10 for the purpose of generating instructions that can execute in the computer system 10. As indicated, the term “module” may refer to a software “procedure” or “function” such as a unit of code that may be independently compiled.

The emulator 44, as well as the compilation system 40 and the O.S. 38, may reside in the computer system 10, more particularly in the computer memory 16 of the computer system 10. The emulator 44 may substitute instructions typically associated with a different computer system than the executing computer system 10, for any original instruction. Any substitute instruction may be associated with a hardware, software, or firmware representation of a different computer system 10.

The data storage device 18 may be any suitable storage device, including a compact disk drive, a tape drive, a removable hard disk drive, or diskette drive. The data storage device 18 may communicate with the I/O adapter 20, which in turn communicates with other components of the computer system 10, in order to retrieve and store data used by the computer system 10. The data storage device 18 typically includes a computer storage medium having stored therein a computer software program and data.

The computer system 10 for embodiments of the invention includes suitable input/output devices for accepting input information and promulgating generated information. Input/output devices may include any suitable storage device, such as a compact disk drive, a tape drive, a removable hard disk drive, or a diskette drive. Suitable input devices include, by way of example only, the keyboard 28, the mouse 30, a touch-screen display (not shown), a touch pad (not shown), a microphone including a voice recognition device (not shown), a network card (not shown), or a modem (not shown). The input devices may communicate with the user interface adapter 26 which in turn communicates with components in the computer system 10 for processing input and output commands. Program code may typically be loaded through a suitable input device and may be stored on the data storage device 18. A copy of the program code, or any portion thereof, may alternatively be disposed by the processor 14 in the computer memory 16 for subsequent execution on the computer system 10.

Output devices may include any suitable output devices for presenting generated information to a user, whether a human or a machine, and whether local or remote. Such devices may include, by way of example only, the computer monitor 34, a printer (not shown), an audio speaker with a voice synthesis device (not shown), a network card (not shown), or a modem (not shown). Output devices, such as the monitor 34, may communicate with other components in the computer system 10 through the display adapter 32.

The computer system 10 for various embodiments of the invention may communicate with communications network 24 via the communications adapter 22, such as a networking card. It is to be appreciated that any suitable input/output device employed by the module 36 may be coupled to the communications network 24 through the communications adapter 22 and therefore may not necessarily be co-located with the computer system 10. Similarly other portions of the computer system 10, such as the data storage device 18 and the monitor 34, may be coupled to the communications network 24 through the communications adapter 22 and may also not be necessarily co-located with the computer system 10.

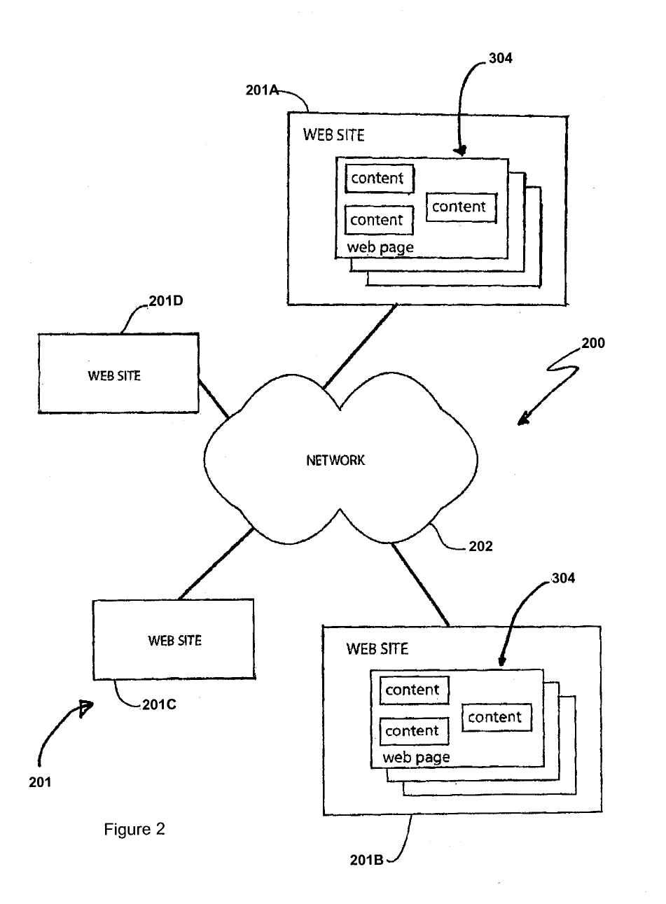

It is to be appreciated that the communications network 24 may be a local area network, a wide area network, or any other suitable computer network, such as network 202 in FIG. 2. Network 202 may be an intranet or the Internet which enables fast and relatively widespread dissemination of information. On the Internet, for example, web sites containing one or more web pages may be accessed by users having a computer system (e.g., computer system 10), a web browser, and a device (e.g., communications adapter 22) for coupling the computer system to the Internet. A web page may contain information on various topics, such as topics (e.g., any and all information and/or input fields needed for selecting a delivery procedure for a product, etc) pertaining to electronic-commerce embodiments of the invention.

Embodiments of the invention will be described in the context of web page publishing on the Internet. It should be understood, however, that embodiments of the invention are not to be limited to web page publishing on the Internet and may be used in any suitable electronic-commerce environment, including intranet, tele-faxing, telephone, and so forth.

Referring again now to FIG. 2, there is seen a web site assembly, generally illustrated as 200, where embodiments of the invention may be employed. In FIG. 2 one or more web sites 201 (e.g., web sites 201A, 201B, 201C and 201D) which couple to and communicate with the network 202. As indicated the network 202 may include the Internet, an intranet or any other type of computer networks.

The web site 201 may be hosted in a computer system, such as computer system 10, or any data processing device which is capable of communication over a network, such as network 202. By way of example only, the web site may be hosted in a web server computer such as those available from, for example, Hewlett-Packard Company. As illustrated in FIG. 2, the web site 201 may include one or more web pages, with each page including various contents, such as images, text, computer programs, downloadable files, audio, video, etc. The web pages may be structured such that they are on various levels. For example, a home page may be presented as a first level web page, with a hyperlink on the home page allowing access to a second level web page, and so on.

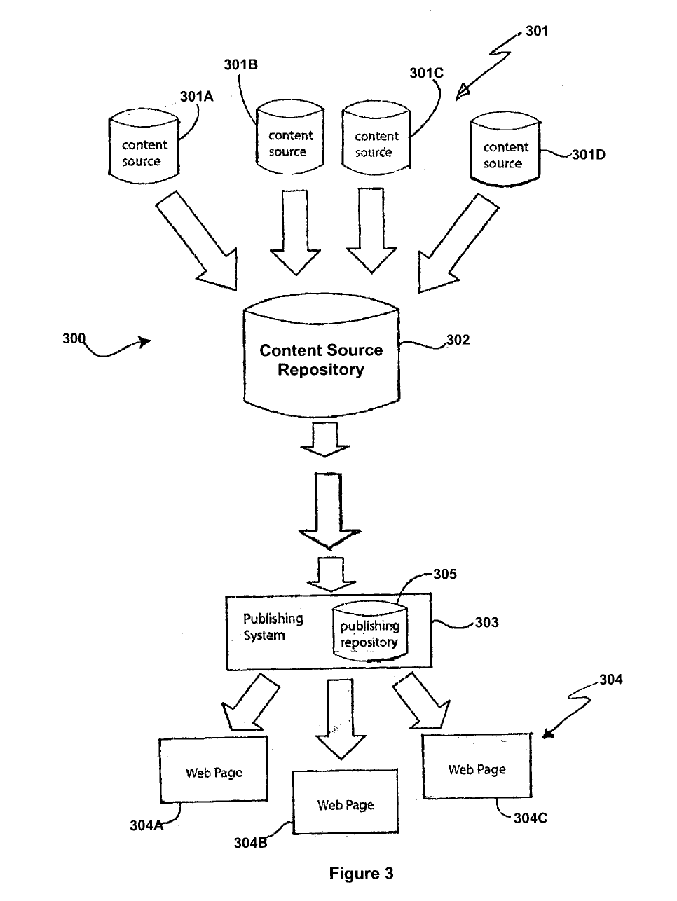

Referring now to FIG. 3, there is illustrated a schematic diagram for a system, generally illustrated as 300, that be used for creating and publishing web pages which may be employed for various embodiments of the invention. The components of system 300, as well as all other components referred to herein, may be implemented in hardware, software, or a combination of hardware and software, such as firmware. As seen in FIG. 3, a content-source repository 302 receives contents from content sources (e.g., content sources 301A, 310B, 301C and 301D). A content source 301 may a local or remote file system, a remote repository (e.g., a repository where carrier shipping methods are stored and maintained), or web site personnel entering content from a suitable terminal, etc. By way of example only, the content source 301 may be a database in a remote data center in communication with a suitable computer system, such as computer system 10, having the content-source repository 302 (e.g., the data storage device 18 functioning as a repository). The content sources may come from various sources, such advertising and sales from a marketing department. For various embodiments of the invention content sources may include a field for receiving a destination code (e.g., a postal zip code), a field for receiving a purchase order, a field for receiving a product ID, a delivery time, a cost of delivery, etc.

The content source repository 302 includes a database that serves as a central repository of contents from the various sources. The database may be any suitable data base such as the type available from, for example, Oracle Corporation. Contents may be stored and retrieved from content source repository 302 as data or objects. Contents uploaded to content source repository 302 from a file system may be stored as binary data or referenced with pointers to the file system.

As appreciated by those artisans skilled in the art, content source repository 302 facilitates collection and retrieval of contents. Contents that may be shared among web pages may be stored in the content source repository 302. By storing appropriate contents in the content source instead of simply entering them directly into a web page, contents from different sources may be created once and used multiple times in different web pages. Content source repository 302 also facilitates control of content type and format so that the resulting web pages conform to a common standard, maintain a consistent look and feel, and uniformly display brands or trademarks and the like.

Appropriate content may be removed or pulled from content source repository 302 as needed by a computer-hosting publishing system 303 which publishes a web page 304 (e.g., web pages 304A, 304B, 304C) in a suitable computer network, such as an intranet or Internet. Publishing system 303 includes a publishing repository 305 (e.g., a database) for storing contents of web pages to be published. As indicated, such contents may be copied from content source repository 302 into a publishing repository 305. This allows web pages 304 to receive content from publishing repository 305.

Storing the content of web pages 304 in publishing repository 305 removes a storage burden from the content source repository 302 and facilitates publication of web pages 304. Additionally, it allows available contents in the provisioning repository 302 to be separated from contents (i.e., those in publication repository 305) which are to be published for better control of the publication process by the publishing system 303 and web pages 304.

A web page 304 may be published by storing it in a web server computer. A web page 304 may also be published by dynamically creating and delivering it to a node in a computer network upon request. Once a web page 304 is published, computers coupled to the same network as the web server computer may then access the web page 304. For example, the web page 304 may be published by making it available from a web site accessible via the intranet or the Internet.

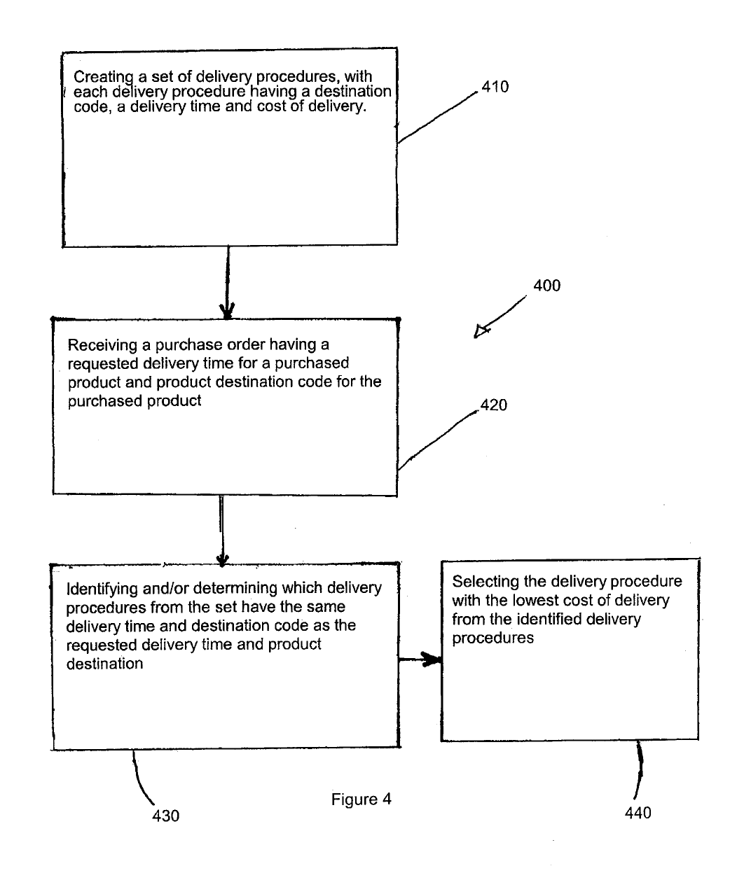

Referring now to FIG. 4, there is seen a block flow diagram, generally illustrated as 400, in accordance with an embodiment of the invention for selecting a delivery procedure for a product. An entity (e.g., a merchant) creates a set of delivery procedures in accordance with instruction block 410. Each delivery procedure within the set of delivery procedures may comprise a method of shipment (e.g., airborne over night, or 2 day delivery by ground, etc), a destination code (e.g., a destination zip code for where a product is to be shipped), a delivery time (e.g., day(s) it takes for product to be delivered or shipped), and cost of delivery or shipment. Stated alternatively, a set of delivery procedures may comprise a plurality of carrier shipping information exemplified by the following Table I, by way of example only and not by limitation:

TABLE I
Carrier Shipping Information

| Method of | Destination | Delivery | Cost of |
|---|---|---|---|
| Shipment | Zip Code | Time (days) | Delivery |
| Ground | 95120 | 2 | $10 |
| Two Day Economy | 95120 | 2 | $20 |
| Overnight | 95120 | 1 | $30 |
| Ground | 12345 | 6 | $10 |
| Two Day Economy | 12345 | 2 | $20 |
| Overnight | 12345 | 1 | $30 |

In practice of embodiments of the invention, for each destination zip code in the United States and in the world, methods of shipment, delivery times and cost of delivery would be created. This information would be obtained from various carriers (e.g., Federal Express, UPS, Airborne Express, Postal Service, etc.). Ideally, the more shipping information received from all available carriers, the more entries may be made in creating the set of carrier shipment information (e.g., the set of delivery procedures). Ideally further, the carrier shipping information (such as exemplified in Table I) would include, for example, thousands, if not millions, of entries. Such entries would be stored in a computer system, such as in the storage device 18 of the computer system 10 of FIG. 1. Obviously, the entries, particularly the delivery times and cost of delivery, would be time sensitive and should be continually updated for accuracy.

After carrier shipping information (e.g., such as that illustrated in Table I) has been gathered by the merchant, the merchant is now in a position for minimizing its cost of delivering a product while simultaneously fulfilling a delivery promise to a customer. In accordance with the instruction of block 420, the merchant would receive a product purchase order (P.O.) from a customer. The product purchase order would include the purchased product ID, the requested delivery time, and the product-destination zip code for the purchased product. Subsequently, the computer system (e.g., computer system 10) identifies and/or determines (in accordance with the instructions of block 430) which delivery procedures (e.g., ground transportation, overnight airborne, etc.) have the same zip code and the same delivery time as that in the purchase order. From those delivery procedures having the same zip code and the same delivery time as that in the purchase order, the computer system selects the delivery procedure or method with the lowest cost, as illustrated by the instructions of block 440. By way of example only, if a purchase order from a customer reflects that the customer desires a product to be shipped to a destination zip code of “95120” and to be received within 2 days, then available shipping methods from Table I that would satisfy these criteria are: “ground” and “two day economy.” The merchant would select the shipping method having the lowest or cheapest cost, which will be “ground” at a cost of $10. The customer would be more concerned with receiving the purchased product within a desired time, as opposed to any particular method of shipping the purchased product. The merchant would be more concerned with selecting the cheapest shipping method that would ship the purchased product to the customer in the requested time frame, as opposed to any particular method of shipping a purchased product. Thus, by the practice of various embodiments of the invention, a merchant is allowed to fulfill a delivery promise to a customer while at the same time minimizing the cost of delivery incurred by the merchant.

Reference throughout this specification to “one embodiment”, “an embodiment”, or “a specific embodiment” means that a particular feature, structure, or characteristic described in connection with the embodiment is included in at least one embodiment of the invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the invention may be combined in any suitable manner with one or more other embodiments. It is to be understood that other variations and modifications of the embodiments of the invention described and illustrated herein are possible in light of the teachings herein and are to be considered as part of the spirit and scope of the invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It is also within the scope of an embodiment of the invention to implement a program or code that can be stored in a machine-readable medium to permit a computer to perform any of the methods described above.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for selecting a procedure for shipping a product, the method comprising comprising:
creating a set of delivery procedures with each delivery procedure having a destination code, a delivery time, and a cost of delivery;
receiving a purchase order having a requested delivery time for a purchased product and a product-destination code for the purchased product; and
selecting from the set a delivery procedure having the lowest cost of delivery and the same delivery time and the same destination code as the requested delivery time and product-destination code.

2. The method of claim 1 additionally comprising: identifying, prior to selecting from the set, which delivery procedures from the set have the same delivery time and the same destination code as the requested delivery time and product-destination code.

3. The method of claim 1 wherein said destination code comprises a postal zip code.

4. The method of claim 2 wherein said destination code comprises a postal zip code.

5. The method of claim 1 wherein said product-destination code comprises a product-destination postal zip code.

6. The method of claim 2 wherein said product-destination code comprises a product-destination postal zip code.

7. The method of claim 3 wherein said product-destination code comprises a product-destination postal zip code.

8. The method of claim 4 wherein said product-destination code comprises a product-destination postal zip code.

9. An article of manufacture comprising:
a machine-readable medium having stored thereon instructions to:
store a set of delivery procedures with each delivery procedure having a destination code, a delivery time, and a cost of delivery;
receive a purchase order having a requested delivery time for a purchased product and a product-destination code for the purchased product; and
select from the set a delivery procedure having the lowest cost of delivery and the same delivery time and the same destination code as the requested delivery time and product-destination code.

10. The article of manufacture of claim 9 wherein said instructions additionally comprise instructions to:
identify, prior to selecting from the set, which delivery procedures from the set have the same delivery time and the same destination code as the requested delivery time and product-destination code.

11. The article of manufacture of claim 9 wherein said destination code comprises a postal zip code.

12. The article of manufacture of claim 10 wherein said destination code comprises a postal zip code.

13. The article of manufacture of claim 9 wherein said product-destination code comprises a product-destination postal zip code.

14. The article of manufacture of claim 10 wherein said product-destination code comprises a product-destination postal zip code.

15. The article of manufacture of claim 11 wherein said product-destination code comprises a product-destination postal zip code.

16. The article of manufacture of claim 12 wherein said product-destination code comprises a product-destination postal zip code.

17. A system for selecting a procedure for shipping a product, the system comprising:
a storage device configured to store a set of delivery procedures with each delivery procedure having a destination code, a delivery time, and a cost of delivery;
a receiving device configured to receive a purchase order having a requested delivery time for a purchased product and a product-destination code for the purchased product; and
a processor coupled to the storage device and to the receiving device and configure to select from the set a delivery procedure having the lowest cost of delivery and the same delivery time and the same destination code as the requested delivery time and product-destination code.

18. The system of claim 17, wherein said destination code comprises a postal zip code.

19. The system of claim 17, wherein said product-destination code comprises a product-destination postal zip code.

20. A system for selecting a procedure for shipping a product, the system comprising:
means for storing a set of delivery procedures with each delivery procedure having a destination code, a delivery time, and a cost of delivery;
means for receiving a purchase order having a requested delivery time for a purchased product and a product-destination code for the purchased product; and
means for selecting from the set a delivery procedure having the lowest cost of delivery and the same delivery time and the same destination code as the requested delivery time and product-destination code.
